(19) United States
(12) Patent Application Publication
(10) Pub. No.: US 2024/0232135 A1
(43) Pub. Date: Jul. 11, 2024

(54) SYSTEM AND METHOD TO MANAGE FILES

(71) Applicant: Stephen J. YUENGER, Port St. Lucie, FL (US)

(72) Inventor: Stephen J. YUENGER, Port St. Lucie, FL (US)

(21) Appl. No.: 18/095,207

(22) Filed: Jan. 10, 2023

(51) Int. Cl. G06F 16/16; G06F 16/11; G06F 16/13; G06F 16/14; G06F 16/174

(52) U.S. Cl. CPC G06F 16/16; G06F 16/116; G06F 16/13; G06F 16/156; G06F 16/1748

(57) ABSTRACT

A method for managing a relational database includes receiving a build request to scan file meta data for a plurality of physical files saved in at least one directory, recording the scanned file meta data in a data frame, sorting the scanned file meta data stored in the data frame into a sorted data frame, converting the sorted data frame to a byte stream, storing the byte stream as a binary file, converting the binary file back to the sorted data frame in response to receiving a search request to find a location of a particular physical file, searching the sorted data frame for a match between the meta data stored in the sorted data frame and the search request for the particular physical file, returning the matched meta data from the sorted data frame to a memory table, and displaying the memory table to the user.

### TECHNICAL FIELD

The present invention relates to the field of computer file management, and, more particularly, to a system and method for building and managing a relational database executed by a computer, wherein the relational database stores the meta data of physical files stored on the computer and is searchable for a user to find the location of a respective physical file.

### BACKGROUND

Current computer systems rely on a file storage design built in the last century. The organization is a tree structure with files located on various branches. These branches can be nested to any level and frequently can exceed many levels.

The file name which includes the FileID (an unstructured character field up to 255 characters long). A period (.) separates the FileID from the Type (suffix—a character field usually 3 to 5 characters), which conveys to an application the internal structure of the file. It can also be pattern-matched to select the default application. The maximum size of the File ID plus Type is 255 characters.

In existing file locator methods, the operating system must search through the tree to find the fully qualified name which is all the directories on the route to the file plus the FileID and Type. The search must go up and back each branch until the file is found and that can take substantial time. With the size of file systems today this pathing is growing and taking more and more time in CPU demand.

When a user creates documents or files or pictures it is normally in the context of a project that is being completed. If the user is following good practices, the user will save that work in a folder (directory) relating to the work effort. Therefore, a letter to “Tom” will be saved in the project folder A, along with a spreadsheet AB for this project. In the event project B requires that spreadsheet AB for analysis, that file is copied to folder B. If any of these files are of significant length, then a relatively large amount of space is required to have the spreadsheet AB saved in both folder A and folder B and much of it wasted due to the duplication.

In addition, when a user requests spreadsheet AB, for example, the user normally will not refer to the project that either created or used it, the user simply asks for AB. Because it may be stored many times in many different folders, the computer must begin searching in all the folders to find it. This creates the issue identified above in the amount of time it takes for the search to go up and back each branch until the file is found.

Accordingly, what is needed is a tool that can search and locate a file in a more efficient manner and can return the location of that file to the user in less time.

### SUMMARY

A method for managing a relational database executed by a computer is disclosed. The relational database stores the meta data and locations of physical files stored on the computer and is searchable for a user to find the location of a respective physical file. The method includes receiving a build request to scan file meta data for a plurality of physical files saved in at least one directory, recording the scanned file meta data in a data frame, and sorting the scanned file meta data stored in the data frame into a sorted data frame. The method also includes converting the sorted data frame to a byte stream and storing the byte stream as a binary file.

In addition, the method includes converting the binary file back to the sorted data frame in response to receiving a search request to find a FileID and all matching FileIDs along with their meta data and location location of the particular physical file, searching the sorted data frame for a match between the meta data stored in the sorted data frame and the search request for the particular physical file, returning the matched meta data from the sorted data frame to a memory table, and displaying the memory table to the user.

The file meta data may be stored in a file record header for each of the physical files, and the data frame comprises a table having rows and columns. The scanned meta data may be sorted in order by at least one of FileID, Date Created, Suffix, File Size, Date Modified, and Date Accessed. The binary file may have a unique file name comprising a date and time when the binary file was stored. In addition, the sorted data frame comprises a plurality of rows, wherein each row includes the respective file meta data for a physical file and the memory table is written to a comma separated values (CSV) file.

The method may include converting the binary file back to the sorted data frame in response to receiving a past request to find whether a particular physical file existed during a past time period, searching the sorted data frame searched for a match with the particular physical file during the past time period, and returning the identification and location of the physical file to a memory table.

In another aspect, the method may include converting the binary file back to the sorted data frame in response to receiving a waste request to find whether any physical files are duplicated, searching the sorted data frame for duplicate files, and returning the identification and location of the duplicate files to a memory table. The method may also include converting the binary file back to the sorted data frame in response to receiving a compare request to find whether a particular file has been altered, searching the sorted data frame for the particular file during a first time period and at least a second time period, comparing the meta data of the particular file from the first time period to the meta data of the at least second time period, and displaying an indicator to the user indicating whether the particular physical file has been altered or not.

The method may include converting the binary file back to the sorted data frame in response to receiving an archive request to find files that have not been accessed for at least a predetermined period of time, searching the sorted data frame for a match of files that have not been accessed for at least the predetermined period of time, and returning the identification and location of those files that have not been accessed to a memory table. In addition, the method may include converting the binary file back to the sorted data frame in response to receiving a reporting request, analyzing the sorted data frame for statistics related to the files stored in the drives and directories, and returning the statistics to a memory table.

In another aspect, a system for managing a relational database executed by a computer is disclosed. The system includes a memory, and one or more processors coupled to the memory and configured to execute computer-readable programming instructions to perform operations. The operations include receiving a build request to scan file meta data for a plurality of physical files saved in at least one directory, recording the scanned file meta data in a data frame, and sorting the scanned file meta data stored in the data frame into a sorted data frame. The operations also include converting the sorted data frame to a byte stream, storing the byte stream as a binary file, and converting the binary file back to the sorted data frame in response to receiving a search request to find a location of a particular physical file.

In addition, the operations include searching the sorted data frame for a match between the meta data stored in the sorted data frame and the search request for the particular physical file, returning the matched meta data from the sorted data frame to a memory table, and displaying the memory table to the user.

In another aspect, a non-transitory machine-readable medium having stored thereon machine-readable instructions executable to cause operations is disclosed. The operations include those described above with respect to the method and system for managing a relational database.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 illustrates an example environment in which various aspects of the disclosure may be implemented;

FIG. 2 is a block diagram illustrating an embodiment of a system for managing a relational database according to an example embodiment;

FIG. 3 depicts a diagram for implementing the system and method for managing a relational database;

FIG. 4 is a schematic illustrating a graphical user interface (“GUI”) of the system;

FIG. 5 depicts a memory table in the form of a spreadsheet displaying meta data according to an example embodiment;

FIG. 6 is a general flow diagram illustrating a process to manage a relational database according to an example embodiment;

FIG. 7 is a flow diagram for explaining a process to build the relational database;

FIG. 8 is a detailed flow diagram for explaining a process to search the relational database;

FIG. 9 is a flow diagram for explaining a process to determine if a file existed in a past time period;

FIG. 10 is a flow diagram for explaining a process to determine if duplicate files are being stored;

FIG. 11 is a flow diagram for explaining a process to determine if a particular file has been altered;

FIG. 12 is a flow diagram for explaining a process to determine which files have not been accessed for a predetermined period of time; and

FIG. 13 is a flow diagram for explaining a process for obtaining file management information.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one of skill in the art upon reading the following disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The system and method of the present invention is a tool that is configured to view file data in a way that humans think of it, by FileID, unencumbered by the location within the folder structure. In addition, the system and method separate this data of the FileID from the actual physical drive to eliminate drive latency from the search time. In particular, it is advantageous to create a virtual view of the file meta data available at a high speed for querying to find any file. This view also permits many management functions such as capacity planning, disaster planning and recovery, and file versioning.

The system and method of the present invention for building and managing a relational database is configured to create the virtual view of a computer's file system as described above. The method is non-destructive as it only reads information from the file system and does not alter it in any way. In addition, the system and method overcome the Windows® file system limitation of 1,046,000 records in any file. The present system and method may implement Pickle streaming technology from Pandas that compresses the output from a DataFrame and streams that data to storage bypassing the write-a-record structure as explained in more detail below. Accordingly, the system and method stores the relational database in 60% of the space normally required for the data involved. The method and system record each action requested by the user and documents the results of the actions and operates from console input based on the choices entered by the user. The choices available are displayed on the console via a graphical user interface (“GUI”) and the operator enters his/her choice.

The system and method are configured to allow the entry of multiple directories and processes each in sequence, scanning the directory for the meta data and recording the information in the Pandas DataFrame. The system and method are also configured to create a complete virtual view of all the selected directories/drives eliminating the need to change references between selections.

The system and method are configured so that at the end of the scan process the DataFrame is sorted by the Skey to put the files in order by FileID, Date Created, Suffix, File Size, Date Modified, and Date Accessed and then the entire DataFrame is streamed to the system using the Python pickle module. The system and method maintain segregation of the data by defining its FileID as FindMyFileyyyymmddhhmmss allowing unique identification to any creation.

The system and method are also configured so that a user can search for any FileID and the user can locate and return results (e.g., in an Excel® worksheet) with all the FileIDs matching the request. In test runs by the inventor it took an average of 3.9 seconds based on multiple test runs with 170,000 files in the storage. This is a significant time saving over existing methods and systems.

The virtual view of the directories and drive is stored for the future so that files can be located and returned from the past from a prior scan and build of the directories and drives. Accordingly, the system and method are configured to compare a first virtual view of the directories and drives at a particular time with a second virtual view of the directories and drives at a second (or different) time. This can be advantageous in a disaster to be able to compare the two virtual views to determine which files need to be recovered. Also, the method and system are configured to compare the 256-bit hash tag to that of the original file to assure no changes were made.

In addition, the system and method can reduce wasted space with duplicate files. The system and method can determine which files have not been accessed recently and may be migrated to archival storage to save active storage space.

The system and method are configured to determine management, or auditors, questions about how the computer system is being used. For example, the system and method are configured to generate a report returning statistics of Min, Avg, Max, Std Deviation for:
length of file name;
depth of directories to file;
duplicates maintained;
file sizes (blocked);
age since creation (blocked); and
age since accessing (blocked)

Referring now to FIG. 1, a computers 102A, 102B, 102C are shown connected to a network 104 in which aspects of the present disclosure may be practiced. A server 106 is also connected to the network 104. Accordingly, computers 102A, 102B, 102C can implement the system and method to manage a relational database locally or through the remote server 106.

The network 104 may be configured in any combination of wired and wireless networks. For example, in some embodiments, the network 104 may be: a local-area network (LAN); a metropolitan area network (MAN); a wide area network (WAN); a primary public network; and a primary private network.

Each of the computers 102A-C and/or server 106 are loaded with an operating system, such as Microsoft Windows® or Apple® Mac OS® and can be programmed to perform particular operations and, in effect, become a special purpose computer when performing these operations. They also have computer-readable memory media, such as fixed drives that can store computer-readable information, such as computer-executable process steps or a computer-executable program for causing the computer to perform a method for managing a relational database as described more fully below.

The server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; or a server executing an application acceleration program that provides firewall functionality, application functionality, or load balancing functionality.

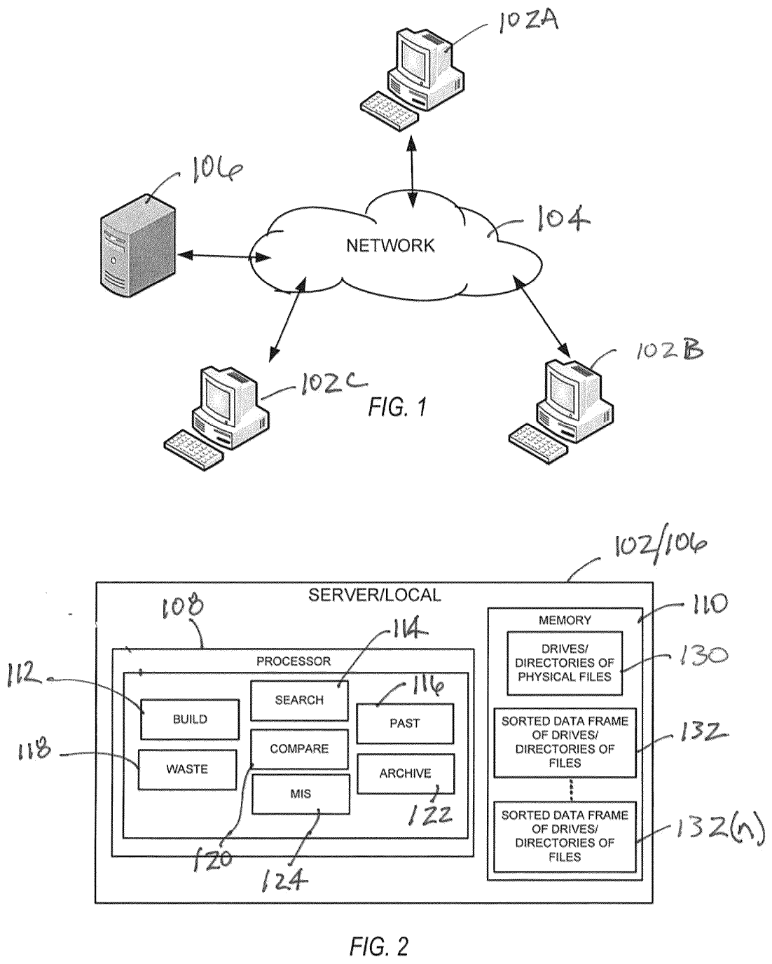

Referring now to FIG. 2, the computer 102 or server 106 includes one or more processors 108 coupled to a memory 110. The memory 110 may comprise a plurality of drives and directories storing physical files 130. In addition, the memory 110 is configured to store sorted data fames of drives/directories of files 132 to 132(n). A plurality of modules comprising a build module 112, a search module 114, a past module 116, a waste module 118, a compare module 120, and archive module 122, and a MIS module 124 are computer executable software code or process steps executable by the processor 108.

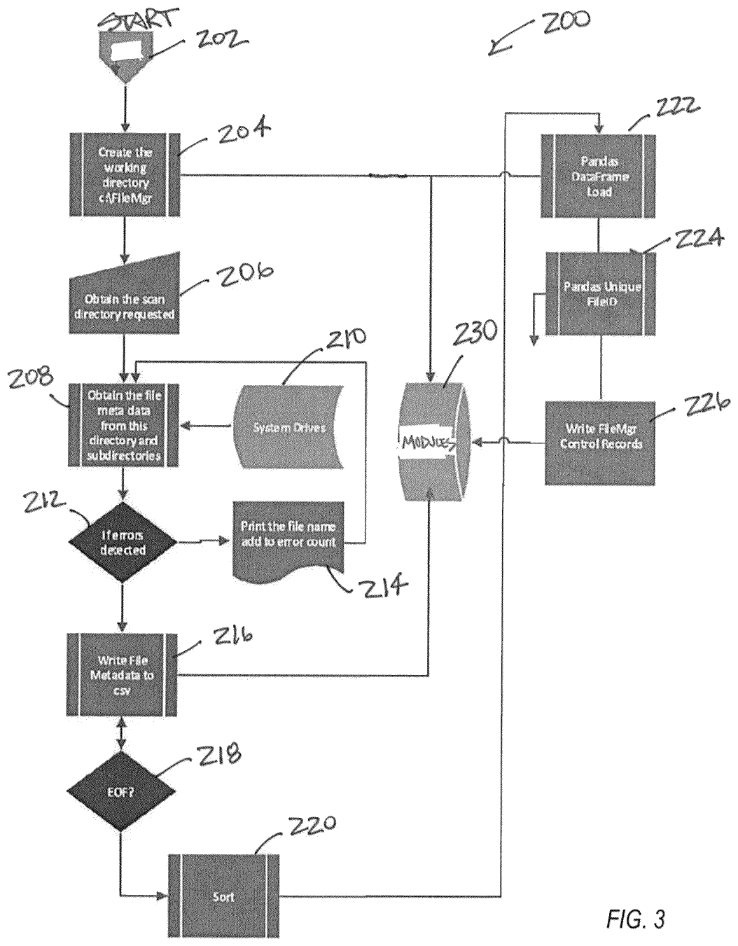

As shown in FIG. 3, a diagram of the system 200 is shown for explaining the build module 112 for building the relational database. The build operation begins at 202. The build operation includes, at step 204, to create the working directory c:\FileMgr, and at step 206, to obtain the scan directory requested. Moving to step 208, the build operation includes to obtain the file meta data from this directory and subdirectories stored on drives 210, and in step 212, to determine if errors were detected. If errors were detected in step 212, then in step 214, to print the file name and add to the error count and return to step 208.

In step 216, the build operation includes to write file meta data to a comma separated values (csv)file until reach end of files, in step 218. The file meta data is sorted in step 220, and in step 222, the sorted file meta data is loaded into a Pandas data frame and, in step 224, the unique FileID is assigned. Moving to step 226, the build operation for the relational database includes write FileMgr control records. The relational database can then be accessed through modules 230 for managing, searching, and analysis.

The csv files can contain a maximum of 1 million rows (windows limits) and there are multiple of these files created as required to support all the scanned files and each one contains a prefix. Once all requested directories are scanned and their meta data saved to a DataFrame and csv, all the csv files are loaded into a DataFrame in sequence and then sorted. The result is written to a Pickle file for future use.

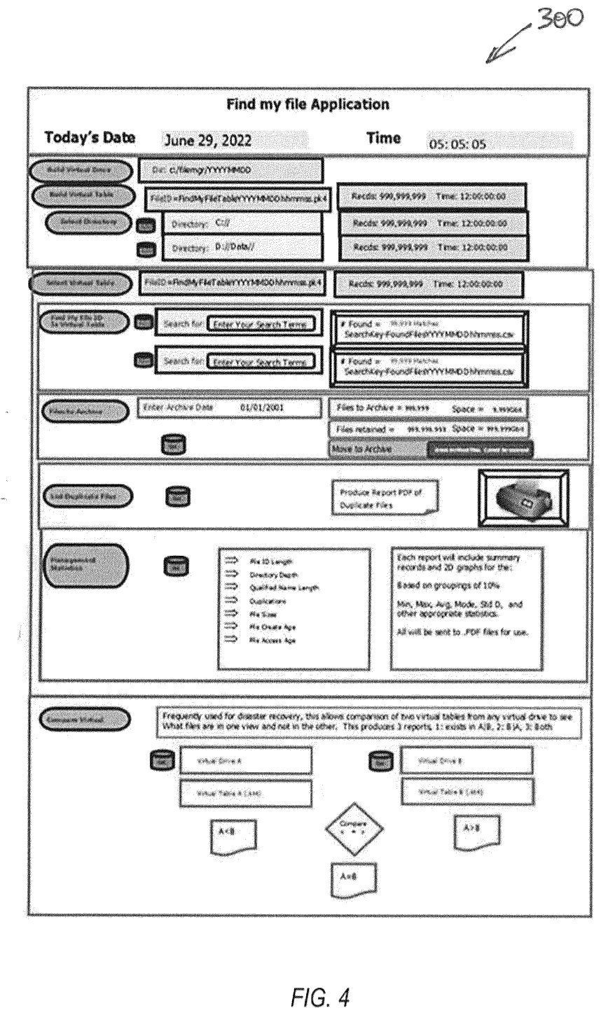

Referring now to FIG. 4, a schematic illustrating a graphical user interface (“GUI”) 300 of the system 200 is shown. A user can use the GUI to perform actions on the computer 102 such as entering the identity of the drive/directory to build a relational database or for searching files. The GUI in FIG. 4 is only an example, and numerous different types of arrangements of the display of files and folders are possible.

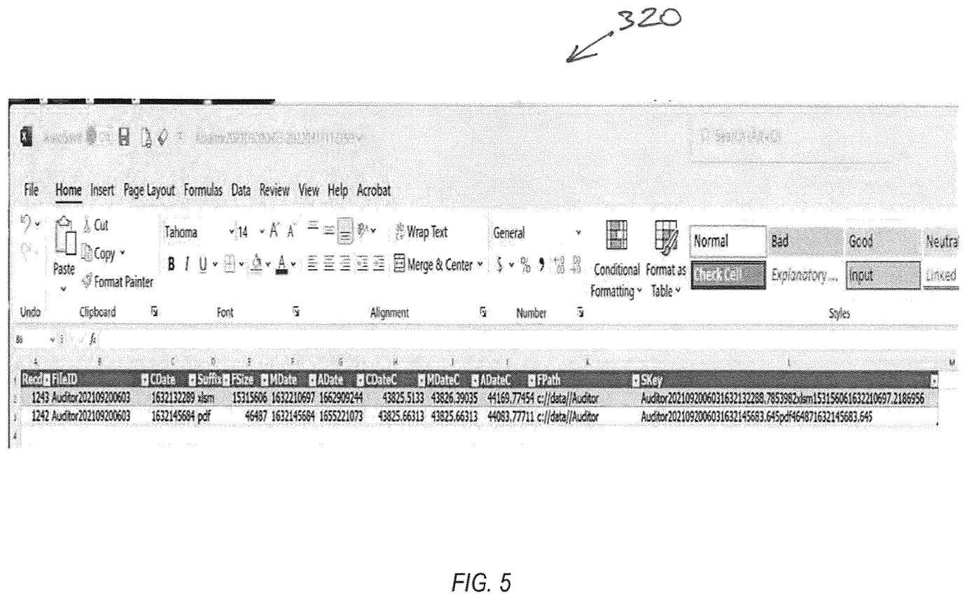

A spreadsheet 320 displaying meta data that was returned after a test run using the system and method is shown in FIG. 5. In this particular example, the user was searching for “auditor”. The system returned the meta data including the file path, FPath, for two files that included the character strong “auditor”.

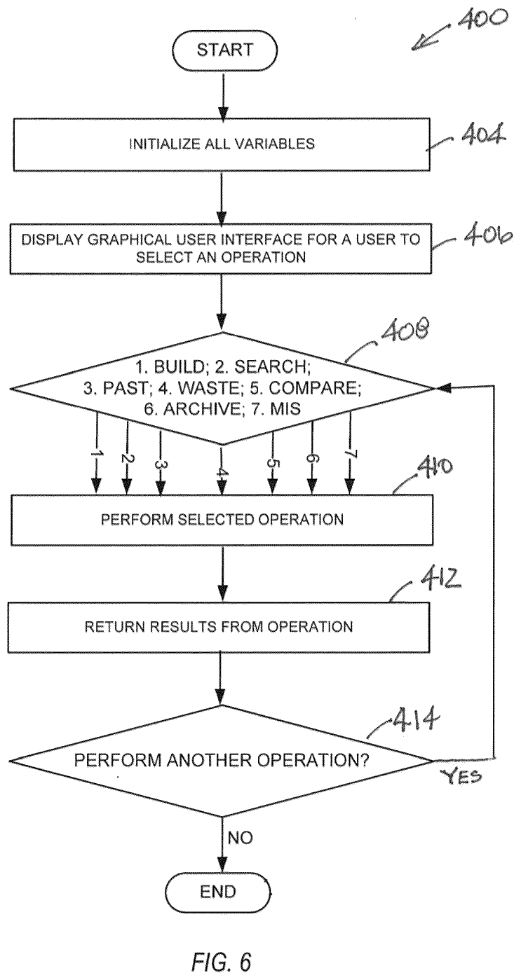

FIG. 6 is a general flow diagram 400 illustrating a process to manage a relational database according to an example embodiment. The process begins at step 404 to initialize all variables. In step 406, the process includes to display the GUI for the user to select an operation to perform. The user selects an operation or module to execute, in step 408, which includes a build module, search module, past module, waste module, compare module, archive module, or MIS module. As those of ordinary skill in the art can appreciate, only one or any combination of the modules can be included with the system and method of the present invention.

Once the user selects the desired operation to perform, the operation is performed in step 410. The results from the operation are returned in step 412. If there are no other operations to perform, at step 414, then the process ends.

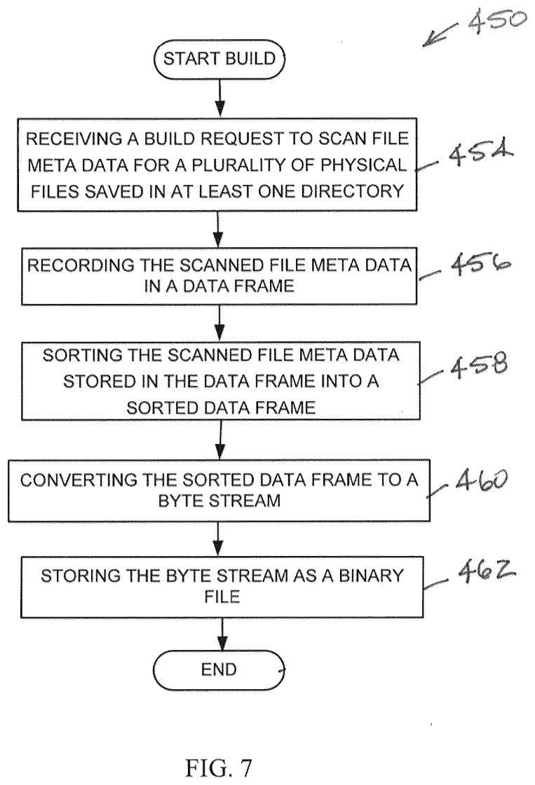

Referring now to FIG. 7, a more detailed flow diagram 450 for explaining a process to build the relational database (the “build” module) is shown. The build request, in step 454, is received and the file meta data from a plurality of physical files saved in at least one directory is scanned. The scanned file meta data is recorded, in step 456, in a data frame. In step 458, the scanned file meta data stored in the data frame is sorted into a sorted data frame, which is considered the relational database. The sorted data frame is then, in step 460, converted to a byte stream. In step 462, the byte stream is stored as a binary file.

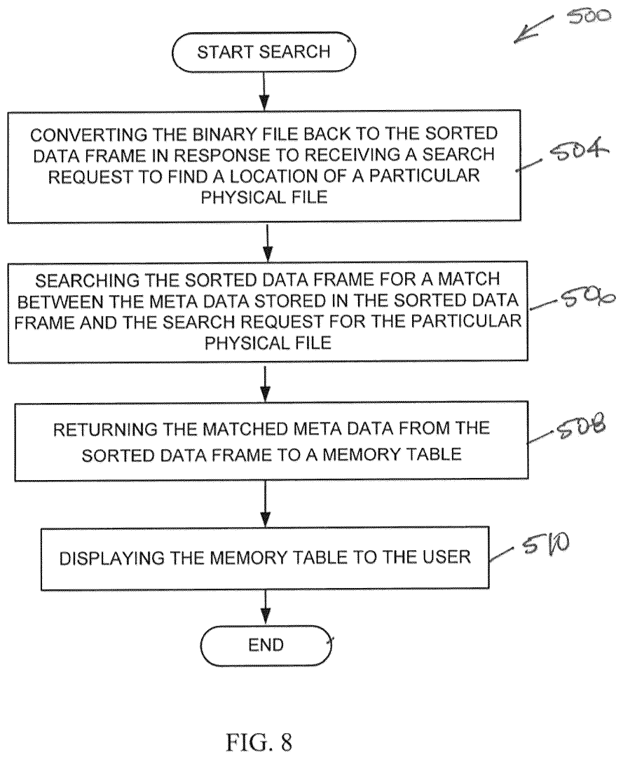

In FIG. 8, a detailed flow diagram 500 for explaining a process to search the relational database (the “search” module) is shown. In response to receiving a search request to find a location of a particular physical file, in step 504, the binary file is converted back to the sorted data frame. In step 506, the sorted data frame is searched for a match between the meta data stored in the sorted data frame and the search request for the particular physical file. The matched meta data from the sorted data frame is returned to a memory table, in step 508. The memory table, in step 510, is displayed to the user.

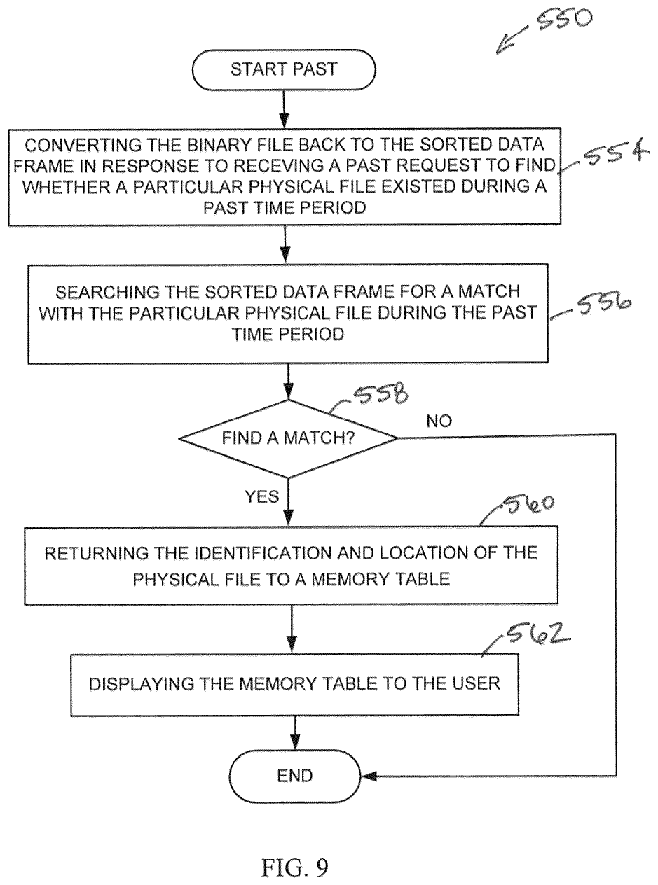

Referring now to FIG. 9, a flow diagram 550 for explaining a process to determine if a file existed in a past time period (the “past” module) using the relational database is shown. The binary file, in step 554, is converted back to the sorted data frame in response to receiving a past request to find whether a particular physical file existed during a past time period. In step 556, the sorted data frame is searched for a match with the particular physical file during the past time period. If there is a match, at step 558, the identification and location of the physical file is returned to a memory table, in step 560. If there is no match the process ends. The memory table, in step 562, is displayed with the identification and location of the physical file to the user.

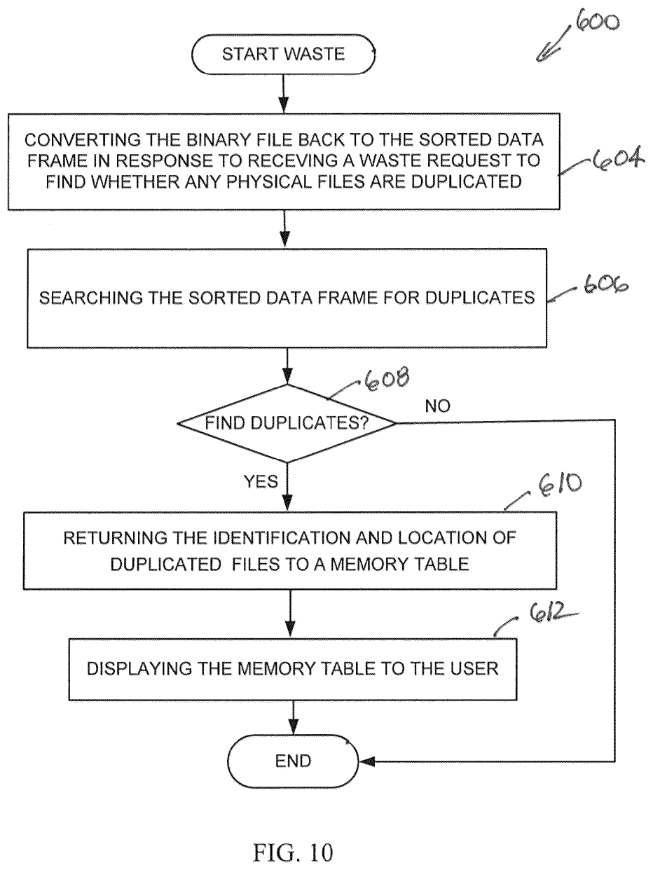

In FIG. 10, a flow diagram 600 for explaining a process to determine if duplicate files are being stored (the “waste” module) using the relational database is shown. The binary file is converted back to the sorted data frame, in step 604, in response to receiving a waste request to find whether any physical files are duplicated. The sorted data frame, in step 606, is searched for duplicates. If no duplicates are found, in step 608, the process ends. If duplicate files are found, in step 608, the identification and location of the duplicated files are returned to a memory table, in step 610. The memory table, in step 612, with the identification and location of the duplicate files is displayed to the user.

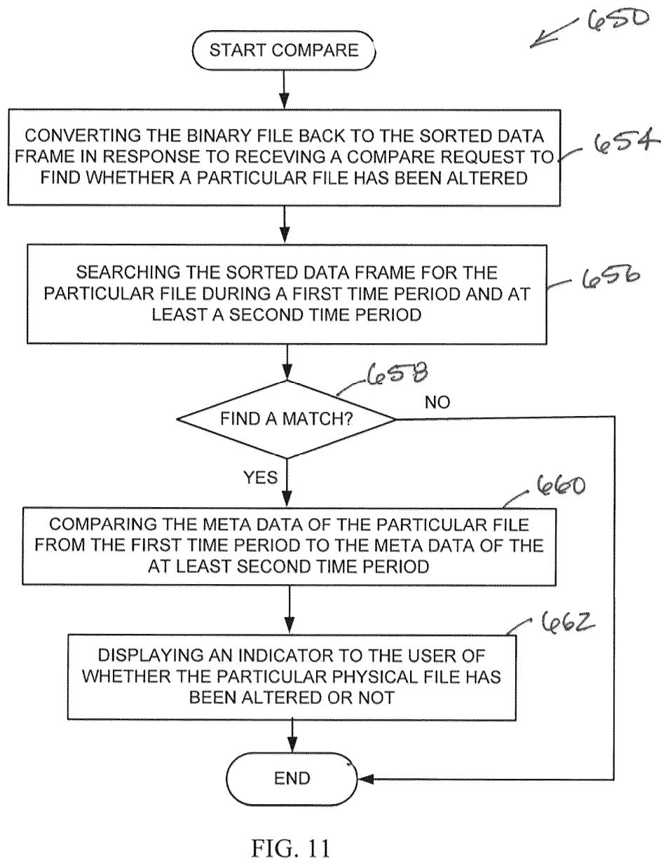

Referring now to FIG. 11, a flow diagram 650 for explaining a process to determine if a particular file has been altered (the “compare” module) using the relational database is shown. Similar to the other modules, the binary file is converted back to the sorted data frame, in step 654, in response to receiving a compare request to find whether a particular file has been altered. The sorted data frame is searched, in step 656, for the particular file during a first time period and at least a second time period. If a match is found, in step 658, the meta data of the particular file from the first time period is compared to the meta data of the at least second time period, in step 660. If no match is found, the process ends. Moving to step 662, an indicator is displayed to the user indicating whether the particular physical file has been altered or not.

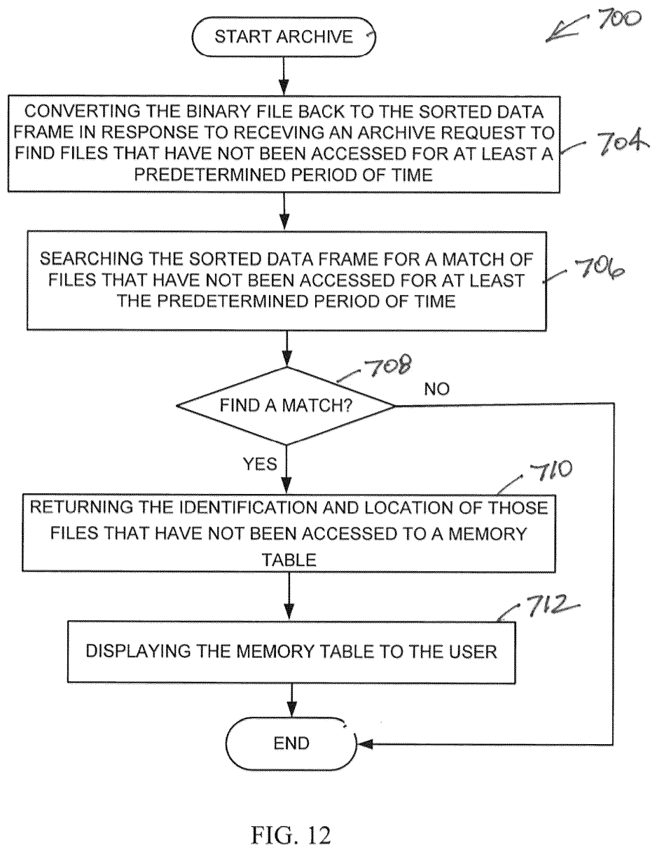

In FIG. 12, a flow diagram 700 is shown for explaining a process to determine which files have not been accessed for a predetermined period of time (the “archive” module) using the relational database. The binary file is converted back to the sorted data frame, in step 704, in response to receiving an archive request to find files that have not been accessed for at least a predetermined period of time. The sorted data frame, in step 706, is searched for a match of a files that have not been accessed for at least the predetermined period of time. If a match is found, in step 708, the identification and location of those files that have not been accessed are returned to a memory table and displayed to the user, in step 712. If no match is found the process ends.

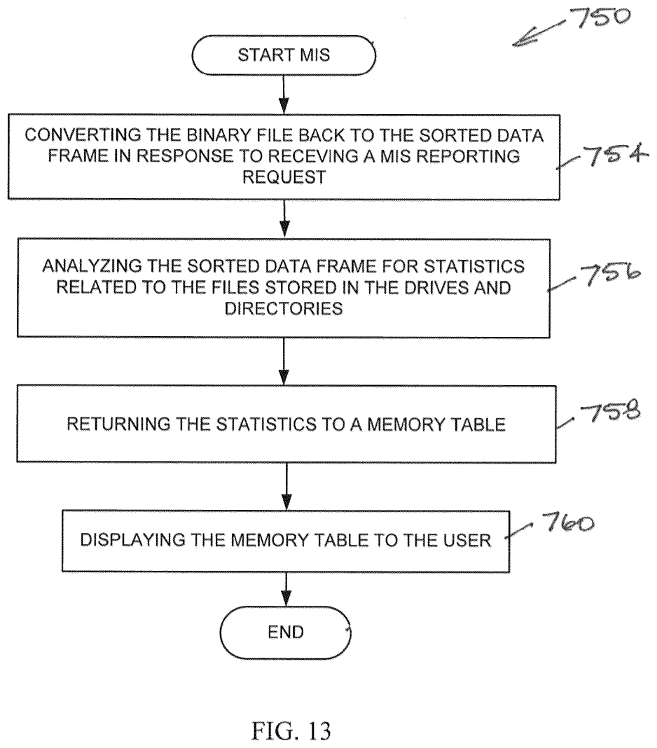

Referring now to FIG. 13, a flow diagram 750 is shown for explaining a process for obtaining file management information (the “MIS” module”) using the relational database. In step 750, the binary file is converted back to the sorted data frame in response to receiving a MIS reporting request. The sorted data frame, in step 756, is analyzed for statistics related to the files stored in the drives and directories. The statistics are returned to a memory table, in step 758, and displayed to the user, in step 760.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A method for managing a relational database executed by a computer, wherein the relational database stores a location of physical files stored on the computer and is searchable for a user to find the location of a respective physical file, the method comprising:
receiving a build request to scan file meta data for a plurality of physical files saved in at least one directory;
recording the scanned file meta data in a data frame;
detecting errors in the scanned file meta data;
identifying a respective file name when an error is detected in the scanned file meta data and adding to an error count;
sorting the scanned file meta data stored in the data frame into a sorted data frame;
converting the sorted data frame to a byte stream; and
storing the byte stream as a binary file.

2. The method of claim 1, wherein the file meta data is stored in a file record header for each of the physical files.

3. The method of claim 2, wherein the data frame comprises a table having rows and columns.

4. The method of claim 3, wherein the scanned meta data is sorted in order by at least one of FileID, Date Created, Suffix, File Size, Date Modified, and Date Accessed.

5. The method of claim 4, wherein the binary file has a unique file name comprising a date and time when the binary file was stored.

6. The method of claim 5, wherein the sorted data frame comprises a plurality of rows, wherein each row includes the respective file meta data for a physical file.

7. The method of claim 6, wherein the scanned file meta data is written to a comma separated values (CSV) file.

8. The method of claim 7, further comprising:
converting the binary file back to the sorted data frame in response to receiving a search request to find a location of a particular physical file;
searching the sorted data frame for a match between the meta data stored in the sorted data frame and the search request for the particular physical file; and
returning the matched meta data from the sorted data frame to a memory table.

9. The method of claim 7, further comprising:
converting the binary file back to the sorted data frame in response to receiving a past request to find whether a particular physical file existed during a past time period;
searching the sorted data frame searched for a match with the particular physical file during the past time period; and
returning the identification and location of the physical file to a memory table.

10. The method of claim 7, further comprising:
converting the binary file back to the sorted data frame in response to receiving a waste request to find whether any physical files are duplicated;
searching the sorted data frame for duplicate files; and
returning the identification and location of the duplicate files to a memory table.

11. The method of claim 7, further comprising:
converting the binary file back to the sorted data frame in response to receiving a compare request to find whether a particular file has been altered;
searching the sorted data frame for the particular file during a first time period and at least a second time period;
comparing the meta data of the particular file from the first time period to the meta data of the at least second time period; and
displaying an indicator to the user indicating whether the particular physical file has been altered or not.

12. The method of claim 7, further comprising:
converting the binary file back to the sorted data frame in response to receiving an archive request to find files that have not been accessed for at least a predetermined period of time;
searching the sorted data frame for a match of files that have not been accessed for at least the predetermined period of time; and
returning the identification and location of those files that have not been accessed to a memory table.

13. The method of claim 7, further comprising:
converting the binary file back to the sorted data frame in response to receiving a reporting request;
analyzing the sorted data frame for statistics related to the files stored in the drives and directories; and
returning the statistics to a memory table.

14. A system for managing a relational database executed by a computer, wherein the relational database stores a location of physical files stored on the computer and is searchable for a user to find the location of a respective physical file, the system comprising:
a memory; and
one or more processors coupled to the memory and configured to execute computer-readable programming instructions to perform operations comprising:
receiving a build request to scan file meta data for a plurality of physical files saved in at least one directory;
recording the scanned file meta data in a data frame;
detecting errors in the scanned file meta data;
identifying a respective file name when an error is detected in the scanned file meta data and adding to an error count;
sorting the scanned file meta data stored in the data frame into a sorted data frame;
converting the sorted data frame to a byte stream;
storing the byte stream as a binary file;
converting the binary file back to the sorted data frame in response to receiving a search request to find a location of a particular physical file;
searching the sorted data frame for a match between the meta data stored in the sorted data frame and the search request for the particular physical file;
returning the matched meta data from the sorted data frame to a memory table; and
displaying the memory table to the user.

15. The system of claim 14, wherein the file meta data is stored in a file record header for each of the physical files, and wherein the data frame comprises a table having rows and columns.

16. The system of claim 15, wherein the scanned meta data is sorted in order by at least one of FileID, Date Created, Suffix, File Size, Date Modified, and Date Accessed, and wherein the binary file has a unique file name comprising a date and time when the binary file was stored.

17. The system of claim 16, wherein the sorted data frame comprises a plurality of rows, wherein each row includes the respective file meta data for a physical file, and wherein the memory table is written to a comma separated values (CSV) file.

18. A non-transitory machine-readable medium having stored thereon machine readable instructions executable to cause operations comprising:
receiving a build request to scan file meta data for a plurality of physical files saved in at least one directory;
recording the scanned file meta data in a data frame;
detecting errors in the scanned file meta data;
identifying a respective file name when an error is detected in the scanned file meta data and adding to an error count;
sorting the scanned file meta data stored in the data frame into a sorted data frame;
converting the sorted data frame to a byte stream;
storing the byte stream as a binary file;
converting the binary file back to the sorted data frame in response to receiving a search request to find a location of a particular physical file;
searching the sorted data frame for a match between the meta data stored in the sorted data frame and the search request for the particular physical file;
returning the matched meta data from the sorted data frame to a memory table; and
displaying the memory table to the user.

19. The non-transitory machine-readable medium of claim 18, wherein the scanned meta data is sorted in order by at least one of FileID, Date Created, Suffix, File Size, Date Modified, and Date Accessed.

20. The non-transitory machine-readable medium of claim 19, wherein the binary file has a unique file name comprising a date and time when the binary file was stored, wherein each row includes the respective file meta data for a physical file, and wherein the memory table is written to a Pickle (.pk4) file.
